(19) United States
(12) Patent Application Publication
(10) Pub. No.: US 2019/0319998 A1
(43) Pub. Date: Oct. 17, 2019

(54) METHOD OF CONTROLLING TRANSMISSION RATE IN STREAMING, AND SYSTEM THEREOF

(71) Applicants: Fingram Co., Ltd., Yongin-si (KR); QURAM Co., Ltd., Yongin-si (KR)

(72) Inventors: Young Cheul WEE, Suwon-si (KR); Tae Hwa Kim, Suwon-si (KR)

(21) Appl. No.: 16/382,441

(22) Filed: Apr. 12, 2019

(30) Foreign Application Priority Data
Apr. 12, 2018 (KR) 10-2018-0042713

(51) Int. Cl. H04L 29/06

(52) U.S. Cl. CPC H04L 65/4092; H04L 65/602; H04L 65/607

(57) ABSTRACT

A method of controlling a transmission rate in streaming image from an image transmission device to an image reception device having a system and at least one client includes: receiving, by the system, image information with a first transmission rate from an image transmission device; transmitting, by the system, client image information corresponding to the received image information to the at least one client; receiving, by the system, subsequent image information with a second transmission rate from the image transmission device; and transmitting, by the system, subsequent client image information corresponding to the received subsequent image information to the at least one client, wherein the second transmission rate is determined by the image transmission device based on feedback information provided by the system to the image transmission device.

### CROSS REFERENCE TO RELATED APPLICATION

This application claims priority from and the benefit of Korean Patent Application No. 10-2018-0042713, filed on Apr. 12, 2018, which is hereby incorporated by reference for all purposes as if fully set forth herein.

### BACKGROUND

### Field

Exemplary implementations of the invention relate generally to a method of controlling a transmission rate in streaming and a system thereof, more specifically, to a method of controlling a transmission rate and a system thereof, which can perform transmission rate (bitrate) control more efficiently by intervening a system for intermediating transmission between a transmitting side and a receiving side.

### Discussion of the Background

In streaming, control of a transmission rate (transmission speed) on the output side is an important factor for efficiency.

The efficiency of streaming relates to a transmission rate on the transmitting side which transmits an image and a reception rate on the receiving side which receives the image. In addition, the reception rate is directly affected by network speed. Here, the image transmitted through the streaming service may include a picture, a video, an audio, etc.

For example, when image information is transmitted at an excessive high transmission rate compared with the reception rate on the receiving side, it may result in unnecessary use of resources in the system of the transmitting side, cause excessive use of resources (e.g., buffer or the like) on the receiving side, or result in repeated transmission of the information.

Contrarily, when the transmission rate is excessively low compared with the reception rate, it directly affects streaming speed and service quality.

Accordingly, it may be important to effectively control the transmission rate in a short time while providing streaming service.

A conventional method of performing streaming service while controlling the transmission rate may be explained with reference to FIG. 1.

FIG. 1 illustrates a conventional streaming service method. Referring to FIG. 1, an image transmission device 10 on the transmitting side may provide a streaming service to a predetermined client 20 installed in a user terminal at a predetermined transmission rate (step S10).

While providing the streaming service, the image transmission device 10 may determine to change the transmission rate according to a predetermined standard of determination (step S20).

Then, the image transmission device 10 may continuously perform the streaming at the changed transmission rate (step S30).

According to the conventional method, the image transmission device 10 may determine a desired transmission rate in a variety of methods.

For example, when the image transmission device 10 is able to directly communicate with the client, and the client is dedicated to the image transmission device 10, the image transmission device 10 may receive information on the reception rate as a feedback from the client and control the transmission rate on the basis of the feedback information.

For another example, the transmission rate may be controlled with reference to the encoding speed of the image transmission device 10 and the amount of image information stored in the buffer of the transmitting side.

However, the former case cannot be applied when the image transmission device 10 cannot directly receive a feedback from a client which is general-purpose client. In addition, the latter case has a disadvantage of adjusting the transmission rate without considering a situation on the receiving side (e.g., a reception rate or the like).

Accordingly, an innovation which can solve the problems is required.

The above information disclosed in this Background section is only for understanding of the background of the inventive concepts, and, therefore, it may contain information that does not constitute prior art.

### SUMMARY

Devices constructed and methods according to exemplary implementations of the invention may provides a method of efficiently controlling a transmission rate by relaying streaming between an image transmission device and a client through a system that can be installed on the user terminal side, and a system thereof.

Furthermore, the devices constructed and methods according to exemplary implementations of the invention may provide a method in which an image transmission device does not need to perform a streaming service customized to a client since the system may perform transcoding according to the need of the client side, and a system thereof.

Additional features of the inventive concepts will be set forth in the description which follows, and in part will be apparent from the description, or may be learned by practice of the inventive concepts.

According to one or more exemplary embodiments of the invention, a method of controlling a transmission rate in streaming image from an image transmission device to an image reception device having a system and at least one client includes: receiving, by the system, image information with a first transmission rate from an image transmission device; transmitting, by the system, client image information corresponding to the received image information to the at least one client; receiving, by the system, subsequent image information with a second transmission rate from the image transmission device; and transmitting, by the system, subsequent client image information corresponding to the received subsequent image information to the at least one client, wherein the second transmission rate is determined by the image transmission device based on feedback information provided by the system to the image transmission device.

The feedback information provided by the system to the image transmission device may include a reception rate of the system.

The feedback information provided by the system to the image transmission device may include identification information of a specific packet received by the system, and the image transmission device may be configured to determine: a delay time of the image information based on the identification information; and the second transmission rate based on the determined delay time.

The feedback information provided by the system to the image transmission device may include a transmission time that the feedback information may be transmitted by the system, and wherein the image transmission device may be configured to determine the second transmission rate based on the transmission time and a reception time that the feedback information may be received by the image transmission device.

The method of controlling a transmission rate in streaming the image may further include the steps of: creating, by the system, the client image information by transcoding the image information; and creating, by the system, the subsequent client image information by transcoding the subsequent image information, wherein the system is configured to transmit at least one of the client image information and the subsequent client image information to a first client.

The client image information may be bypassed information of the image information and the subsequent client image information may be bypassed information of the subsequent image information, and the system may be configured to transmit at least one of the client image information and the subsequent client image information to a second client.

The method of controlling a transmission speed in streaming may further include the step of receiving, by the system, information on the first client from a user, wherein the system may be configured to perform transcoding based on the received information on the first client.

According to one or more exemplary embodiments of the invention, a method of controlling a transmission rate in streaming of an image transmission device includes: streaming out, by the image transmission device, image information with a first transmission rate to a system; receiving, by the image transmission device, a feedback information from the system; and streaming out, by the image transmission device, subsequent image information after the first transmission rate based on the basis of the feedback information, the second transmission rate being different from the first transmission, wherein the system may be configured to transmit at least one of client image information and subsequent client image information corresponding to the image information and the subsequent image information, respectively, to a client, and the client is configured to play the at least one of the client image information and subsequent client image information.

According to one or more exemplary embodiments of the invention, a system installed in an image reception device includes: a reception module for receiving image information from an image transmission device at a first transmission rate; an output module for generating client image information corresponding to the received image information and transmitting the client image information to at least one client; and a control module for generating feedback information and providing the feedback information to the image transmission device, wherein the reception module may be configured to receive subsequent image information from the image transmission device at a second transmission rate, the output module may be configured to generate subsequent client image information corresponding to the subsequent image information and transmit the subsequent client image information to the at least one client, and the second transmission rate may be determined by the image transmission device based on the feedback information.

The system may further include a transcoding module for creating the client image information by transcoding the image information and creating the subsequent client image information by transcoding the subsequent image information.

According to one or more exemplary embodiments of the invention, an image transmission device includes: a streaming module for streaming out image information with a first transmission rate to a system; and an interface module for receiving feedback information from the system, the streaming module may be configured to change the first transmission rate to a second transmission rate based on the feedback information; and stream out subsequent image information to the system, the system is configured to transmit at least one of client image information and subsequent client image information corresponding to the image information and the subsequent image information, respectively, to a client, and the client may be configured to play the at least one of the client image information and the subsequent client image information.

A computer-readable medium may store instructions that, when executed by a computer, causes it to perform the above method of controlling a transmission rate in streaming image.

According to one or more exemplary embodiments of the invention, a data processing device includes: a processor; and a memory for storing instructions that, when executed by the processor, causes it to perform the above method of controlling a transmission rate in streaming image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates a conventional streaming service method.

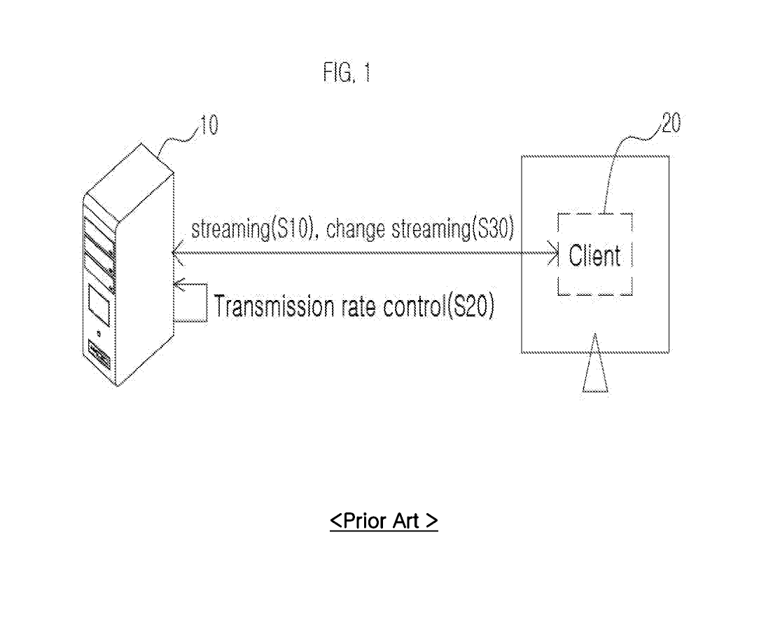

FIG. 2 is illustrates a method of controlling a transmission speed in a streaming service according to an exemplary embodiment.

FIG. 3 is a schematic drawing illustrating an exemplary configuration of a system according to an exemplary embodiment.

FIG. 4 is a schematic drawing illustrating an exemplary configuration of an image transmission device according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In the specification, when any one of constitutional components “transmits” a data to another constitutional component, it means that the constitutional component may directly transmits the data to another constitutional component or may transmit the data to another constitutional component through at least one of the other constitutional components. On the contrary, when any one of the constitutional components directly transmits a data to another constitutional component, it means that the data is transmitted to another constitutional component without passing through the other constitutional components.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the present invention is described in detail focusing on the exemplary embodiments of the present invention with reference to the attached drawings. Like reference symbols presented in each drawing denote like members.

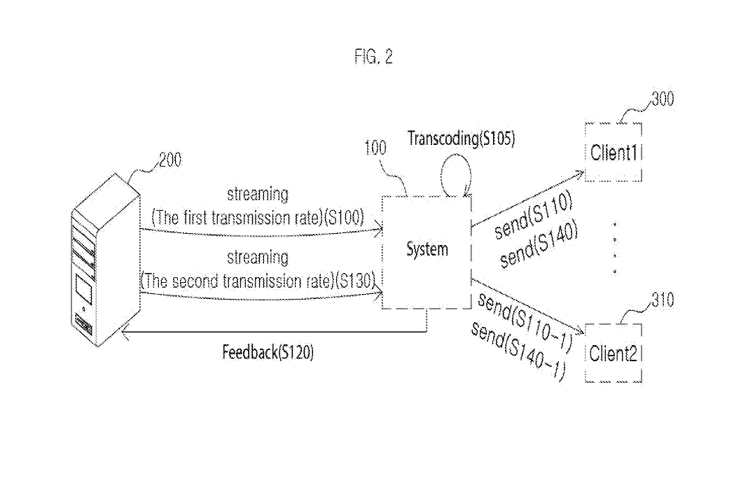

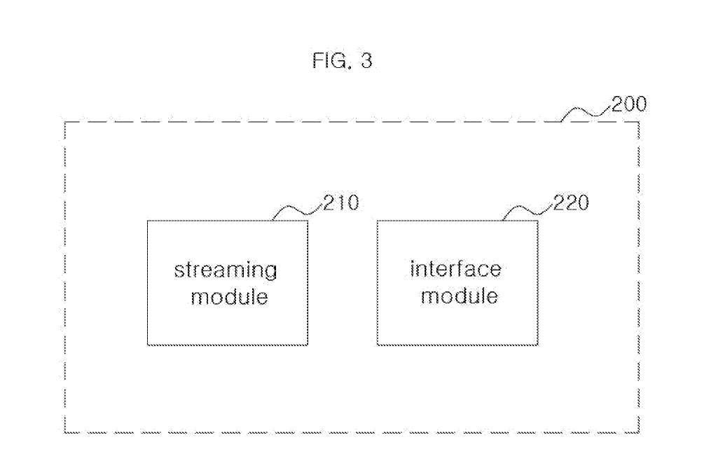

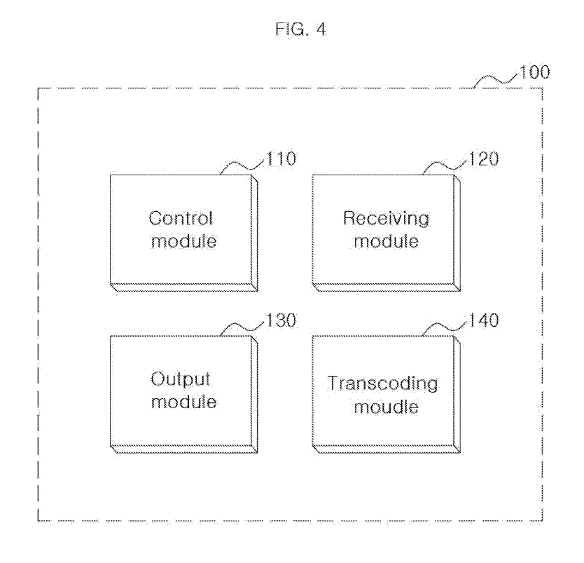

FIG. 2 is a view showing a method of controlling a transmission rate in a streaming service according to an exemplary embodiment. FIG. 3 is a view showing the schematic configuration of a system according to an exemplary embodiment, and FIG. 4 is a view showing the schematic configuration of an image transmission device according to an exemplary embodiment. Here, the image transmitted through the streaming service may include a picture, a video, an audio, etc.

First, referring to FIG. 2, a system 100 may be provided to implement a method of controlling a transmission rate in streaming according to the exemplary embodiments.

The system 100 may mean a system organically combining software for implementing the functions defined in this specification and hardware for driving the software according to the exemplary embodiments.

According to an exemplary embodiment, a user may install software corresponding to the system 100 in an image reception device (e.g., a computer, a mobile phone or the like) that the user himself or herself uses, to implement the system 100. Then, the system 100 can be implemented through organic combination of the software, which is implemented by the image reception device, and the image reception device.

According to exemplary embodiments, although the system 100 may be implemented as a physical device separate from a device in which a client (e.g., a moving image player or the like) which plays back a streaming is installed, in this specification, an example of providing the system 100 and the client embodied together in the image reception device will be described.

The system 100 may receive streamed image information from the image transmission device 200 and perform a function of relaying the image information to the client.

That is, instead directly streaming an image between an image transmission device and a client in a conventional method, a user may install the system 100, which performs the function of relaying the streaming, according to the exemplary embodiments.

The system 100 may relay the streamed image information in real-time or may store and relay later the streamed image information to the client side at an appropriate time. That is, the system 100 may perform delayed streaming as needed.

As the system 100 relays the streaming, the user may effectively control the transmission rate (transmission bitrate) in real-time through other clients (e.g., clients other than clients distributed by the subject of the image transmission device 200), not a client dedicated to the image transmission device 200.

Although the client may not directly provide predetermined feedback information (e.g., reception rate (receiving bitrate) or identification information (header information or the like) of a specific packet described below) since the client is a client unknown to the image transmission device 200, the system 100 according to the exemplary embodiments is able to provide the feedback information while relaying the streaming information. In addition, the bitrate control may not be additionally required between the system 100 and the client.

In addition, when the system 100 performs a function of relaying the streaming services, the services may be easily provided to further diverse clients. That is, compared with providing a service customized to a client one by one by according to the request from the image transmission device 200 side, it may be much more effective to be provided with the system 100 and perform a service customized to the client, for example, transcoding to an environment (a file type, a protocol or the like) appropriate to the client as descried below, by the system 100. To this end, if the system 100 receives a certain client type, it may further perform transcoding, if needed, to be appropriate to the client.

For example, the system 100 may perform protocol conversion for steaming image information. That means the system 100 may perform streaming in a protocol different from the transmission protocol between the image transmission device 200 and the system 100, to at least a client (e.g., clients 300 and 310).

For example, a first client 300 may be a client which needs to perform the transcoding of protocol conversion, and a second client 310 may be a client which does not need such transcoding.

In this case, the system 100 may transcode the received image information in real-time (or at an appropriate time point after temporarily storing the information) and transmit the transcoded image information to the first client 300 and transmit image information to the second client 310 by bypassing the received image information.

Accordingly, the system 100 may effectively provide streaming service to diverse client environments installed in the user terminal.

In addition, the system 100 may perform a function of providing feedback information for controlling the transmission rate of the image information streamed from the image transmission device 200. Accordingly, the image transmission device 200 is able to receive the feedback information at all times regardless of whether communication with the client is possible. Therefore, the system 100 according to the exemplary embodiments may provide much more accurate and effective bitrate control compared with the conventional bitrate control performed only through the transmission environment of the transmitting side.

The image reception device provided with the system 100 and/or at least one of clients 300 and 310 may be implemented using any data processing device capable of implementing the functions defined in the specification. For example, the image reception device may be a data processing device possessed or occupied by a user, such as a notebook computer, a smart phone, a tablet PC, a laptop computer, a desktop computer, a mobile terminal, a PMP, a PDA or the like, and it can be implemented as any device if the device is a device in which the system 100 according to the exemplary embodiments can be implemented.

Although the image transmission device 200 may be a predetermined streaming server, according to exemplary embodiments, it may be implemented as a camera, broadcasting equipment, a mobile phone, a computer or the like having a streaming function.

The system 100 includes a control module 110, a reception module 120 and an output module 130 as shown in FIG. 3. The system 100 may further include a transcoding module 140 as needed.

According to an exemplary embodiment, some constitutional components among the constitutional components described above may not correspond to constitutional components essentially needed for implementation of the present invention, and in addition, according to exemplary embodiments, the system 100 may include much more constitutional components than these.

The system 100 may be provided with hardware resources and/or software needed for implementing the exemplary embodiments, and it does not necessarily means a physical constitutional components or a device. That is, the system 100 may mean a logical combination of hardware and/or software provided to implement the exemplary embodiments and may be implemented, if needed, as a set of logical configurations installed in devices spaced apart from each other to implement the exemplary embodiments by performing their functions.

In addition, a module in this specification may mean a functional or structural combination of hardware according to the exemplary embodiments and software for driving the hardware. For example, the module may mean a logical unit of a predetermined code or hardware resources for performing the predetermined code, and it may be easily inferred by those skilled in the art that the module does not necessarily mean a physically connected code or a kind of hardware.

The control module 110 may control the functions and/or resources of other configurations included in the system 100, for example, the reception module 120, the output module 130, the transcoding module 140 and the like.

The reception module 120 may receive image information from the image transmission device 200. In this specification, image information before the image transmission device 200 changes the transmission rate is simply expressed as image information, and for the convenience of explanation, image information streamed to the system after the transmission rate is changed is expressed as subsequent image information. However, the image information and the subsequent image information are not divided as information itself, and those skilled in the art may easily infer that the image information and the subsequent image information are information on a series of continuous images.

In addition, for the convenience of explanation, image information that the system 100 streams to a client is expressed as client image information, and particular client image information, among the client image information, received after the transmission rate is changed and transmitted to the client through the system 100 is expressed as subsequent client image information.

The output module 130 may transmit the client image information and/or the subsequent client image information to at least a client (e.g., clients 300 and 310). That is, the output module 130 may relay the streaming. Although the output module 130 may relay streaming of the image information received in real-time, it may store the received image information and stream the stored image information to at least a client (e.g., clients 300 and 310) after a predetermined time is elapsed as needed.

In addition, to carry out streaming customized to each client, the system 100 may transcode the received image information and stream the transcoded image information to at least a client (e.g., clients 300 and 310). To this end, the transcoding module 140 may be included in the system 100.

The transcoding module 140 may store, in advance, information needed for customizing for each client. The transcoding module 140 may also store, in advance, information on a standard protocol (e.g., real-time streaming protocol (RTSP)) or information on a specification that can be generally used for streaming.

In addition, if the user inputs information on a client (e.g., identification information such as a client name, an icon or the like) who desired to receive streaming from the system 100, the system 100 may check customizing information appropriate to the client and perform transcoding to correspond to the checked information.

Apparently, it is possible to stream the received image information, as needed, by bypassing the image information to a client who does not need transcoding.

The control module 110 may feedback predetermined feedback information to the image transmission device 200. The feedback information may be information that can be used by the image transmission device 200 to effectively change the transmission rate.

According to an exemplary embodiment, the feedback information may include information on the reception rate of image information streamed from the image transmission device 200. The control module 110 may have the image transmission device 200 to control the transmission rate in real-time by providing information on the reception rate as feedback information at regular intervals. According to the exemplary embodiments, the transmission rate control may be selectively performed when there is a change in the reception rate greater than a predetermined level. Those skilled in the art may easily infer that the control module 110 may provide information on the reception rate as feedback information in a variety of ways.

According to another embodiment, the control module 110 provides the feedback information including identification information of a specific packet (e.g., the first packet or a packet received at a predetermined position in an order of receiving packet) included in the image information. For example, header information of the specific packet may be included in the feedback information. In any case, it is sufficient if the identification information of the specific packet is included.

As soon as the specific packet is received or after a predetermined time is elapsed, the control module 110 may provide feedback by generating and transmitting the feedback information. Then, the image transmission device 200 may measure a delay time on the basis of a difference between the time of transmitting the specific packet and the time of receiving the feedback information, and control the transmission rate on the basis of the delay time (a round trip delay in this case).

The control module 110 may include a transmission time of the feedback information in the feedback information. In this case, the delay time (a unidirectional delay in this case) may be simply calculated on the basis of a difference between the time of receiving the feedback information by the image transmission device 200 and the transmission time of the feedback information.

According to exemplary embodiments, although predetermined other information may be further included in the calculation of the delay time, the delay time may also be calculated on the basis of the feedback information in any case. In addition, the transmission rate may be controlled according to a change in the delay time, not an absolute value of the delay time.

For example, the transmission rate may be adjusted to be lowered when the reception rate is lower than the transmission rate by a predetermined level or more. If the difference between the transmission rate and the reception rate is not so significant, a function of finding an optimal transmission rate may be performed by increasing the transmission rate and confirming again the reception rate.

In any case, the image transmission device 200 may control the current streaming bitrate, i.e., the transmission rate, on the basis of the received feedback information.

A series of these processes are described below with reference to FIG. 2.

The image transmission device 200 may stream image information to the system 100 according to the exemplary embodiments, not directly performing the streaming to the client (step S100). At this point, the streaming transmission rate of the image transmission device 200 may be, for example, a first transmission rate. Initially, the first transmission rate may have a default value.

Then, the system 100 may perform streaming of image information to the client (e.g., clients 300 and 310) by relaying the received image information (step S110 and S110-1). Apparently, if needed, the transcoding module 140 of the system 100 may transcode the image information to be customized to the first client 300 and stream the transcoded client image information to the first client 300.

In addition, for the second client 310, the system 100 may stream the image information by bypassing the image information.

Meanwhile, the system 100 may provide the image transmission device 200 with feedback information of the image information streamed at the first transmission rate (step S120). Then, the image transmission device 200 may control the transmission rate on the basis of the received feedback information.

The image transmission device 200 may determine a desired transmission rate, i.e., a second transmission rate, and perform streaming of subsequent image information (i.e., image information following the image information streamed before the transmission rate is changed) with the changed transmission rate (step S130).

Then, the system 100 may receive the subsequent image information and relay streaming of subsequent client image information corresponding to the received subsequent image information to at least a client (e.g., clients 300 and 310). Furthermore, if necessary, the transcoding may further be performed in this case.

Meanwhile, as shown in FIG. 4, the image transmission device 200 according to the exemplary embodiments may include a streaming module 210 and an interface module 220.

The streaming module 210 may stream out the image information to the system 100 with a predetermined transmission rate.

The interface module 220 may receive, from the system 100, feedback information of the image information received by the system 100.

Then, the streaming module 210 may determine a desired transmission rate on the basis of the received feedback information. Then, the streaming module 210 may perform streaming after changing the streaming transmission rate to the determined transmission rate. Those skilled in the art may easily infer that various bitrate control methods, such as changing an encoding bitrate and/or controlling the bitrate at the network output terminal, may be used to change the streaming transmission rate.

According to implementation examples, the above system 100 may include a processor and a memory for storing a program executed by the processor. The processor may include a single core CPU or a multi-core CPU. The memory may include a high-speed random access memory and may also include one or more of non-volatile memory such as a disk storage device, a flash memory device and other non-volatile solid state memory devices. Access to the memory by the processor and other constitutional components may be controlled by a memory controller. Here, the program, when being executed by the processor, may have a system 100 according to this embodiment to perform the method of controlling a transmission speed in streaming described above.

Meanwhile, the method of controlling a transmission speed in streaming according to an exemplary embodiment may be implements in the form of a computer-readable program command and stored in a computer-readable medium, and control programs and target programs according to an exemplary embodiment may also be stored in a computer-readable medium. The computer-readable recording medium includes all kinds of recording devices in which data that can be read by a computer system can be stored.

The program command recorded in the recording medium may be a program command specially designed and configured for the present invention or a program command known to and used by those skilled in the art of the computer software field.

The computer-readable recording medium includes, for example, magnetic media such as a hard disk, a floppy disk and a magnetic tape, optical recording media such as a CD-ROM and a DVD, magneto-optical media such as a floptical disk, and hardware devices specially configured to store and execute program commands, such as a ROM, a RAM, a flash memory and the like. In addition, the computer-readable recording medium may be distributed in computer systems connected through a network, and a code that can be read by a computer in a distributed manner can be stored and executed therein.

The program command includes, for example, a high-level language code that can be executed by a device which electronically processes information using an interpreter or the like, for example, a computer, as well as a machine code generated by a compiler.

The hardware devices described above can be configured to operate using one or more software modules in order to perform the operation of the present invention, and vice versa.

The scope of the present invention is represented by the claims described below rather than the detailed description, and it is to be interpreted that the meaning and scope of the claims and all the changes or modified forms derived from the equivalent concepts thereof are included in the scope of the present invention.

According to the exemplary embodiments, as streaming between an image transmission device and a client is intermediated through a system that can be installed on the user terminal side, the transmission rate may be effectively controlled.

In addition, as information on the reception rate of the receiving side is provided as feedback information for effective control of the transmission rate or information for calculating a delay time of a network by the transmitting side is provided as feedback information, the transmission rate may be effectively controlled.

In addition, the system is able to perform a streaming service customized to a client although the image transmission device without performing the streaming one by one since the system may perform transcoding according to the need of the client side, and therefore, the service convenience of the service providing side may be enhanced.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of controlling a transmission rate in streaming image from an image transmission device to an image reception device comprising a system, the method comprising the steps of:
receiving, by the system, image information with a first transmission rate from an image transmission device;
transmitting, by the system, client image information corresponding to the received image information to at least one client;
receiving, by the system, subsequent image information with a second transmission rate from the image transmission device; and
transmitting, by the system, subsequent client image information corresponding to the received subsequent image information to the at least one client,
wherein the second transmission rate is determined by the image transmission device based on feedback information provided by the system to the image transmission device.

2. The method according to claim 1, wherein the feedback information provided by the system to the image transmission device comprises a reception rate of the system.

3. The method according to claim 1, wherein the feedback information provided by the system to the image transmission device comprises identification information of a specific packet received by the system, and
wherein the image transmission device is configured to determine:
a delay time of the image information based on the identification information; and
the second transmission rate based on the determined delay time.

4. The method according to claim 1, wherein the feedback information provided by the system to the image transmission device comprises: a transmission time that the feedback information is transmitted by the system, and
wherein the image transmission device is configured to determine the second transmission rate based on the transmission time and a reception time that the feedback information is received by the image transmission device.

5. The method according to claim 1, further comprising the steps of:
creating, by the system, the client image information by transcoding the image information; and
creating, by the system, the subsequent client image information by transcoding the subsequent image information,
wherein the system is configured to transmit at least one of the client image information and the subsequent client image information to a first client.

6. The method according to claim 5, wherein the client image information is bypassed information of the image information and the subsequent client image information is bypassed information of the subsequent image information, and
wherein the system is configured to transmit at least one of the client image information and the subsequent client image information to a second client.

7. The method according to claim 5, further comprising the step of receiving, by the system, information on the first client from a user,
wherein the system is configured to perform transcoding based on the received information on the first client.

8. A method of controlling a transmission rate in streaming of an image transmission device, the method comprising the steps of:
streaming out, by the image transmission device, image information with a first transmission rate to a system;
receiving, by the image transmission device, feedback information from the system; and
streaming out, by the image transmission device, subsequent image information with a second transmission rate based on the feedback information, the second transmission rate being different from the first transmission,
wherein the system is configured to transmit at least one of client image information and subsequent client image information corresponding to the image information and the subsequent image information, respectively, to a client, and
wherein the client is configured to play the at least one of the client image information and the subsequent client image information.

9. A system installed in an image reception device, the system comprising:
a reception module for receiving image information from an image transmission device at a first transmission rate;
an output module for generating client image information corresponding to the received image information and transmitting the client image information to at least one client; and
a control module for generating feedback information and providing the feedback information to the image transmission device,
wherein the reception module is configured to receive subsequent image information from the image transmission device at a second transmission rate,
wherein the output module is configured to generate subsequent client image information corresponding to the subsequent image information and transmit the subsequent client image information to the at least one client, and
wherein the second transmission rate is determined by the image transmission device based on the feedback information.

10. The system according to claim 9, further comprising a transcoding module for creating the client image information by transcoding the image information and creating the subsequent client image information by transcoding the subsequent image information.

11. An image transmission device comprising:
a streaming module for streaming out image information with a first transmission rate to a system; and
an interface module for receiving feedback information from the system,
wherein the streaming module is configured to:
change the first transmission rate to a second transmission rate based on the feedback information; and
stream out subsequent image information to the system,
wherein the system is configured to transmit at least one of client image information and subsequent client image information corresponding to the image information and the subsequent image information, respectively, to a client, and
wherein the client is configured to play the at least one of the client image information and the subsequent client image information.

12. A computer-readable medium storing instructions that, when executed by a computer, causes it to perform the method of claim 1.

13. A data processing device comprising:
a processor; and
a memory for storing instructions that, when executed by the processor, causes it to perform the method of claim 1.
